(19) United States
(12) Patent Application Publication
(10) Pub. No.: US 2015/0373320 A1
(43) Pub. Date: Dec. 24, 2015

(54) VISUAL COGNITION SYSTEM

(71) Applicant: PHOTON-X, Kissimmee, FL (US)

(72) Inventors: David Scott Ackerson, Easton, MD (US); Blair Allen Barbour, Kissimmee, FL (US)

(21) Appl. No.: 14/749,100

(22) Filed: Jun. 24, 2015

Related U.S. Application Data
(60) Provisional application No. 62/016,617, filed on Jun. 24, 2014.

(51) Int. Cl. H04N 13/02

(52) U.S. Cl. CPC H04N 13/0275

(57) ABSTRACT

A visual cognition system immersed in a medium with object and the system is also an object. The system includes means for conveying energy, which include one or more dispersive elements. The system includes means for sensing energy. The means for sensing include a plurality of detectors. The system includes means for modeling sensed energy, thereby creating a sensed energy model. The sensed energy model represents the sensed energy at a plurality of frequency bands, a plurality of polarization states, a plurality of positions and a plurality of times, using the sensed data. The system includes means for modeling a scene, thereby creating a scene model. The scene model represents the scene in three-dimensional space. The means for modeling a scene uses the sensed energy model from a plurality of directions at a plurality of times.

### RELATED APPLICATION

The present application claims benefit of priority of U.S. Patent Application No. 62/016,617 filed Jun. 24, 2014, the entire disclosure of which is incorporated herein by reference.

### BACKGROUND OF THE INVENTION

1. Field of the Invention

The present invention relates to the field of 3D imaging.

2. Discussion of Prior Art

A review of the literature reveals related approaches and art which are discussed below. Within the discussion it should be noted that “SPI” refers to Spatial Phase Imaging, which is a method of 3D imaging that can be used to determine shape. “4D” in the context of SPI refers to the fact that the camera creates output that can be used to build scene models that have three spatial and one temporal dimension. “SfP” is an acronym for Shape from Polarization, which refers to a technology for determining shape from the polarization state of electromagnetic energy proceeding from a surface.

### SPI/SfP Patents

Wolff patent U.S. Pat. No. 5,028,138 discloses basic SfP apparatus and methods based on specular reflection. Diffuse reflections, if they exist, are assumed to be unpolarized. Barbour patent U.S. Pat. No. 5,557,261 discloses a video system for detecting ice on surfaces such as aircraft wings based on polarization of electromagnetic energy, but does not disclose a SfP method. Barbour/Chenault patent U.S. Pat. No. 5,890,095 discloses a SPI sensor apparatus and a micropolarizer array. Barbour/Stilwell patent U.S. Pat. No. 6,671,390 discloses the use of SPI cameras and methods to identify and track sports equipment (such as soccer balls) and participants on an athletic field based on integrating polarization sensitive materials into clothing and equipment. Barbour patent U.S. Pat. No. 6,810,141 discloses a general method of using a SPI sensor to provide information about objects, including information about 3D geometry. d'Angelo/Wohler patent DE102004062461 discloses apparatus and methods for determining geometry based on shape from shading (SfS) in combination with SfP. d'Angelo/Wohler patent, DE102006013316, discloses apparatus and methods for determining geometry based on SfS in combination with SfP and a block matching stereo algorithm to add range data for a sparse set of points. Morel et. al. patent WO 2007057578 discloses an apparatus for SfP of highly reflective objects. Barbour/Ackerson patent WO 2011071929 discloses a 3D visualization system based on SPI SFP that is improved upon in various ways in this application, including

### SfP Publications

The Koshikawa paper, “A Model-Based Recognition of Glossy Objects Using Their Polarimetrical Properties,” is generally considered to be the first paper disclosing the use of polarization information to determine the shape of dielectric glossy objects. Later, Wolff showed in his paper, “Polarization camera for computer vision with a beam splitter,” the design of a basic polarization camera. The Miyazake paper, “Determining shapes of transparent objects from two polarization images,” develops the SfP method for transparent or reflective dielectric surfaces. The Atkinson paper, “Shape from Diffuse Polarization,” explains the basic physics of surface propagating and describes equations for determining shape from polarization in the diffuse and specular cases. The Morel paper, “Active Lighting Applied to Shape from Polarization,” describes an SfP system for reflective metal surfaces that makes use of an integrating dome and active lighting. The Morel paper, “Active Lighting Applied to Shape from Polarization,” explains the basic physics of surface propagating and describes equations for determining shape from polarization in the diffuse and specular cases. The d'Angelo Thesis, “3D Reconstruction by Integration of Photometric and Geometric Methods,” describes an approach to 3D reconstruction based on sparse point clouds and dense depth maps.

### DISCUSSION OF COMPETITIVE TECHNOLOGIES

This application will teach those skilled in the art to build a new type of visual cognition system resembling a conventional 2D video camera in size, operation and cost; but able to model everyday scenes with 3D fidelity rivaling that of human beings. One of many teachings is a real-time modeling approach for utilizing dynamically sensed spatial phase characteristics to represent everyday scenes (such as a family in a room, or a dog in a backyard). Said another way, the teaching is to utilize spatial phase characteristics sensed as the scene is changing to simultaneously a) build surfaces of different morphologies (rigid, deformable and particle, for example) and b) determine camera locations. Also, because orientation can be directly determined from spatial phase characteristics, spatiotemporal shape rather than intensity contrast can be relied upon to accomplish tasks such as segmentation, correspondence and geometry from motion.

Spatiotemporal shape contrast has several benefits over intensity contrast. First, features based on shape contrast are pose and illumination invariant for rigid surfaces. This enables algorithms in areas such as segmentation, correspondence and geometry from motion to be more robust than comparable algorithms based upon intensity contrast. Second, shape contrast is the only available source of contrast in certain situations. The situation depicted in FIGS. 1A and 1B provides one such practical example (similar colors in low light conditions). Another example of this second benefit are instructive: in the visible spectrum, a white ball bouncing inside a white integrating sphere provides no intensity contrast and cannot be “seen” by a conventional video camera or, for that matter, human eyes. The scene would be readily be imaged by the new visual cognition system taught by this application.

The exemplary embodiment disclosed in this application is a visual cognition system. Before describing the embodiment, we will briefly explain the benefits of 3D video in general, market needs relative to 3D video, and potentially competitive 3D video technologies, 3D video being one of the applications of visual cognition in general.

It is understood that many visually cognitive devices need components, which resemble the visual cognition systems described in this patent application that we may refer to as “cameras”, but that have little external resemblance to digital cameras. Rather they are components embedded in other larger systems such as robots, cars and appliances.

### Benefits of 3D Video

The benefits of 3D video relative to 2D video are significantly improved visualization and remarkably improved visual cognition (automated extraction of information from sensors of electromagnetic radiation).

Highly Realistic (HR) Visualization. When a system can create a notion of a scene in the mind of a human that is as realistic or almost as realistic as directly viewing the scene, we say that the visualization system is HR. An imaging system has to be 3D to be HR, since human sight is 3D. But, there's more to HR than 3D . . . the imaging system must also have speed and resolution that meets or exceeds that of the human visual system. The invention disclosed in this patent enables HR visualization. But, the value of HR visualization pales in comparison to the value of visual cognition, which is described next.

Visual cognition. Visual cognition means understanding the state of the physical world by sensing and analyzing electromagnetic energy as it interacts with the world. Automatic recognition of human emotions, gestures and activities represent examples of visual cognition. Cognitive inspection (e.g. how much hail damage was done to a car based on visual inspection) is another example. 2D video cameras struggle to provide a high level of visual cognition under many real world situations because they throw away depth information when a video is captured. As a consequence of neglecting depth, 2D images of Objective 3D scenes are inferior to 3D images. FIGS. 1A and 1B and FIG. 2 illustrate this point. FIGS. 1A and 1B show two depictions of a man in camoflage against a camoflaged background under poor lighting conditions. The depiction on the left, FIG. 1A, is a photo captured with a conventional 2D camera. The depiction on the right, FIG. 1B, is a 2D rendering of a reconstructed 3D surface model 505 created with a 3D scene camera. The 3D scene camera obviously sees the man much more clearly than the 2D camera, because the sensed shape of the man easily differentiates him from the background in this particular real-world situation (dusk). 3D images have better contrast under real-world conditions (the ability to distinguish between different objects). FIG. 2 shows a photo of two Eiffle Towers that appear to be approximately the same size. Our minds suggest that the tower being held by the man is smaller than the tower on the right, but one cannot establish the sizes with any certainty in 2D image. One may think that the FIG. 1 and FIG. 2 photos are contrived, but video of real scenes typically contains dozens of instances where contrast and depth ambiguity make it difficult for automated systems to understand the state of the scene.

### 3D Video Market Needs

3D visual cognition systems do everything that 2D cameras do, but add the benefits just discussed. It is reasonable to assume that global production of most cameras will shift to 3D if and when 3D scene cameras become cost effective. However, the market will require the following before such a shift occurs:

Compactness. The physical size of the 3D Visualization Systems must be similar to that of comparable 2D video cameras. The digital size of 3D video data must be small enough to enable storage on reasonably sized media and transfer in reasonable intervals of time.

Visual Fidelity. Visual fidelity today must be at least comparable to that of human eyes in all three dimensions.

Simple Operation. The process of recording a 3D video must be as simple as recording a 2D video.

Low Cost. Costs of 3D video equipment must be similar to that of 2D video equipment for corresponding applications and manufacturing volumes.

### Competitive Technologies

FIG. 3 classifies 3D surface imaging technologies in terms of four broad categories: Spatial Phase Imaging (SPI), Triangulation, Time of Flight (TOF) and Coherent approaches. Spatial Phase Imaging, which includes aspects of the present invention, generally relies on the polarization state of light as it emanates from surfaces to capture information about the shape of objects. Triangulation employs the location of two or more displaced features, detectors and/or illuminants to compute object geometry. Two important triangulation subcategories are monocular correspondence (MOC) and stereoscopy (STY). Monocular cameras determine the location of features in a scene by identifying corresponding features in two or more offset spectral images using 3D geometry to compute feature locations (multiple cameras separated by baselines can also be used to accomplish the same task). Stereoscopic cameras rely on human biological systems (eyes, brain) to create a notion of a three dimensional scene from two conventional (2D) images taken from different vantage points and projected into the eyes of a viewer. Time of Flight (TOF) approaches rely on the time that is required for electromagnetic energy to make a round trip from a source to a target and back Finally coherent methods rely on a high degree of spatial and/or temporal coherence in the electromagnetic energy illuminating and/or emanating from the surfaces in order to determine 3D surface geometry.

Within the broad 3D imaging categories, there are several video technologies that directly or indirectly compete with SPI: stereoscopic imaging (STY), monocular correspondence (MOC) imaging and Time of Flight (TOF) imaging. Rigorous comparisons are beyond the scope of this application. Suffice it to say that each of the competing technologies fails to satisfy customer requirements in the large un-served markets discussed above in at least one important way.

Stereoscopic imaging (STY). Stereoscopic imaging systems rely on human eyes and brains to generate a notion of 3D space. No scene model is actually created. No 3D editing or analytical operations are possible using STY and automation is impossible (by definition . . . a human being is in the loop).

Monocular correspondence (MOC). Monocular correspondence cameras fail the visual fidelity requirement, since they can only determine point coordinates where unambiguous spectrally contrasting features (such as freckles) can be observed by two cameras. Large uniform surfaces (e.g., white walls) which can be reconstructed using embodiment cameras and systems cannot be reconstructed using MC.

Time of flight (TOF). Time of flight cameras fail the visual fidelity requirements in two ways. First, TOF resolution is relatively poor. The best TOF lateral and depth resolutions (since we are focused on cameras, we are considering large FPAs) are currently about 1 cm, which are, respectively, one or two orders of magnitude more coarse than required for the un-served markets like those mentioned above. Second, TOF cameras cannot capture common scenes that include objects as vastly different depths. For example, it is not practical to record scenes including faces and mountains at the same time.

### SUMMARY OF THE INVENTION

The following simplified summary provides a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides a visual cognition system. The system is immersed in a medium. One or more objects are immersed in the medium. The system is also an object. Electromagnetic energy propagates in the medium. The objects, the energy and the medium comprise a 3D scene. The boundaries between the objects and the medium are surfaces. Some of the electromagnetic energy scatters from the surfaces. The system includes means for conveying energy, which include one or more dispersive elements. The means for conveying receives some of the energy from the scene. The system includes means for sensing energy. The sensed energy is received from the means for conveying. The means for sensing include a plurality of detectors. The detectors detect the intensity of sensed energy at video rates and at high dynamic range, thereby creating sensed data. The system includes means for modeling sensed energy, thereby creating a sensed energy model. The sensed energy model represents the sensed energy at a plurality of frequency bands, a plurality of polarization states, a plurality of positions and a plurality of times, using the sensed data. The system includes means for modeling a scene, thereby creating a scene model. The scene model represents the scene in three-dimensional space. The means for modeling a scene uses the sensed energy model from a plurality of directions at a plurality of times.

In accordance with another aspect, the present invention provides a visual cognition system for digitizing scenes or extracting information from visual sensing of scenes. The system includes means for conveying electromagnetic energy emanating from at least one 3D surface included in a scene that includes one or more dispersive elements that are sensitive to frequency and spatial phase characteristics of the electromagnetic energy as the configuration of the 3D surfaces relative to the system changes. The system includes means for creating a scene model utilizing the spatial phase characteristics sensed in a plurality of configurations.

### BRIEF DESCRIPTION OF THE DRAWINGS

The foregoing and other aspects of the invention will become apparent to those skilled in the art upon reading the following description with reference to the accompanying figures and glossary.

FIGS. 1A and 1B are two similar photographic type images, but the right image (FIG. 1B) shows 3D contrast achievable in accordance with an aspect of the present invention;

FIG. 2 is a photograph showing depth ambiguity, which can be avoided in accordance with an aspect of the present invention;

FIG. 3 is a chart showing comparisons among 3D imaging technologies including technology in accordance with the present invention;

FIG. 4A is a schematic representation of an example 3D camera, in accordance with an aspect of the present invention and at a high level;

FIG. 4B is a schematic representation of example details of a portion of the 3D Camera of FIG. 4A, which includes sensing means, processing means and display means;

FIG. 5A is an example of an optical system that may be used with a 3D camera with spatial phase characteristic sensing means;

FIG. 5B is a schematic representation of a portion of a focal plane array showing arrangements of four subpixels at 0, 45, 90 and 135 degree polarization axis angles and showing two sets of four subpixels each used to sense surface element orientation;

FIG. 5C is a schematic used to define terms used in the on-chip subtraction algorithm used with a 3D camera with spatial phase characteristic sensing means;

FIG. 6 is an example 3D Scene Modeling Means Flowchart for a 3D camera;

FIG. 7A is a conventional photograph of a woman;

FIG. 7B is a 3D scene model of the woman shown within FIG. 7A depicting normal vectors;

FIG. 7C is a 3D scene model of the woman shown within FIG. 7A;

FIG. 7D is a photograph of a bas-relief sculpture;

FIG. 8A is a conventional photograph showing a hiker on a precipice;

FIG. 8B is a segmented 3D scene model of the scene shown within FIG. 8A;

FIG. 8C is a conceptual view of associated with the scene shown within FIG. 8A and showing some coordinate frames;

FIG. 9 is a photograph of a playing card showing, in false color, a spatial phase characteristic tag; and

FIG. 10 is a diagram which illustrates the sequence of reactions used to prepare taggant IR1.

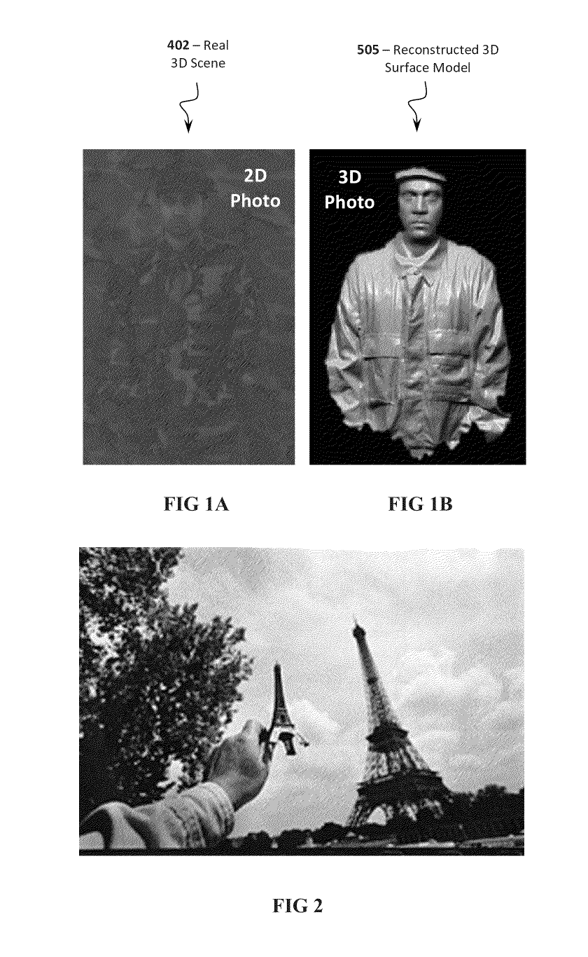

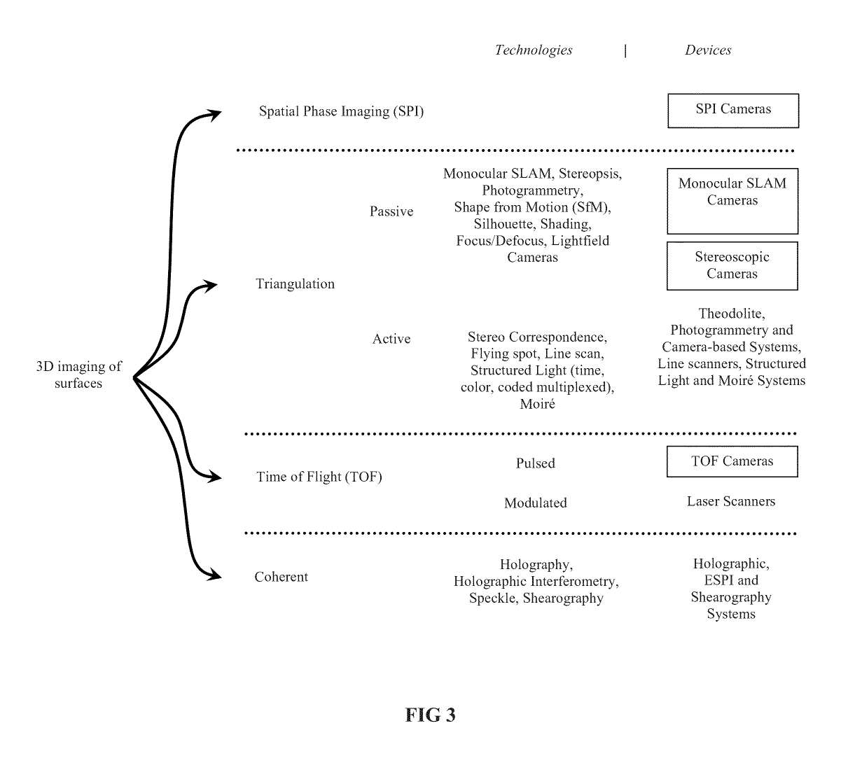

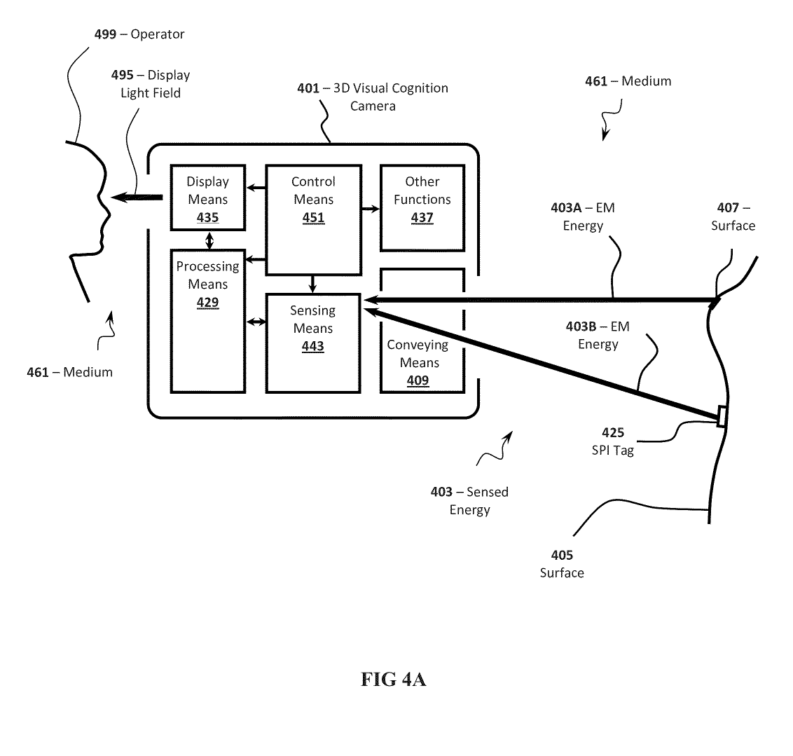

### DETAILED DESCRIPTION

### Glossary of Terms

For ease of reference, the following terms are provided:

Camera. A device that senses electromagnetic energy to create images.

Characteristic. An attribute of an entity that can be represented. Examples of characteristics include length, color and shape.

Class. One or more characteristics used to categorize entities.

Display. A device that stimulates human senses to create notions of entities such as objects and scenes. Examples of displays include flat panel TVs and speakers.

Entity. Anything that can be represented.

Image. Characteristics of electromagnetic energy at one or more locations in a scene at a moment in time. Examples of images include hyperspectral image cubes, spatial phase images, and pictures.

Location. Position and/or orientation characteristics of entities in a scene.

Model. A representation of an entity that is objective.

Medium. Material of uniform composition that fills the space between objects in a scene. Examples of mediums include empty space, air and water.

Notion. A representation of an entity that is subjective.

Object. Matter that belongs together in a scene. Examples of objects include a leaf, a forest, a flashlight, a sensor and a pond.

Objective. What we presume to exist in the physical universe independent of human consciousness.

Real. The entity represented by its representation.

Representation. An objective or subjective prototype of an entity.

Scene. A spatiotemporal region of the universe filled with a medium, into which one or more objects are immersed and electromagnetic energy propagates.

Sensor. A device that senses a scene to create a model of one or more scene characteristics. Examples of sensors include photon counters, thermometers and cameras.

Spatial Phase Characteristics. Characteristics of electromagnetic energy that represent the polarization state of electromagnetic energy.

Subjective. What we presume to exist in the human consciousness.

Surface. A boundary between objects and a medium.

Video. A plurality of images of a scene that can be referenced to a common spatiotemporal frame.

The distinction in the meaning of the words “real scene”, “scene model”, and “notion of the scene” should be apparent from the definitions above. The word “scene” used in this patent application will generally have one or more of these meanings, depending on the context in which the word is used. Words that describe the other entities defined above (e.g. “surface”) have analogous meanings.

### Introduction

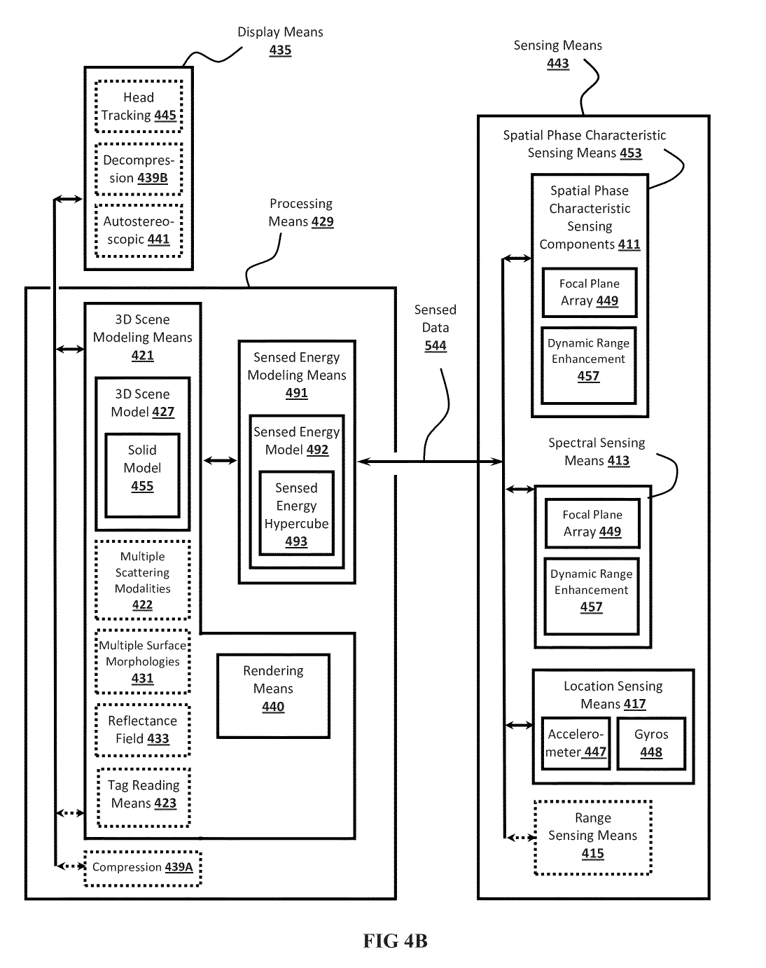

FIG. 4A depicts an exemplary embodiment, which is a passive, monocular, visual cognition system (e.g., camera) 401 that works in the visible spectrum. The visual cognition system (e.g., camera) 401 is an object as are the portions/components thereof. The camera 401 can be used by an operator 499 to create a 3D Scene Model 427 (FIG. 4B), which might be a 3D video or information extracted from the 3D Scene Model 427 (FIG. 4B), such as the degree a car is damaged by hail. The exemplary camera 401 resembles a consumer video camera in appearance and operation and captures 3D video at 30 frames per second and locally displays the 3D video using the visual display means 435.

The exemplary camera 401 is immersed in a medium 461. The objects in the medium, electromagnetic energy proceeding within the medium and the medium comprise a 3D scene. Boundaries between the objects and the medium are surfaces. The sensing means (or means for sensing) 443 detects characteristics including spatial phase characteristics of electromagnetic energy 403A emanating from surface 405 (of an example object), via conveying means (or means for conveying) 409. The sensing means 443 also detects phase characteristics of electromagnetic energy 403B emanating from spatial phase characteristic tag 425 on surface 405 via the conveying means 409. The sensed energy 403 is the part of the scene energy (not shown). The output of the sensing means 443 is available to a processing means 429. The output of the processing means 429 is available to a real-time visual display means 435. The output of the real-time visual display means 435 is available to the eye of a camera operator 499 by way of the display light field 495. Certain other camera 401 means are depicted in other figures or are not mentioned at all.

FIG. 4B reveals more detail about the sensing means (or means for sensing) 443, the processing means 429 and the display means 435. The sensing means 443 further includes a spatial phase characteristic sensing means 453, the spectral sensing means 413 and a location sensing means 417. The spatial phase characteristic sensing means 453 further includes spatial phase sensing components 411. The spatial phase sensing components 411 and the spectral sensing means 413 further include a focal plane array 449 and a dynamic range enhancement means 557. The location sensing means 417 further includes linear accelerometers 447 and gyros 448. The sensed data 544 that are available to the processing means 429 include spatial phase characteristics from the spatial phase sensing components 411, location characteristics from the location sensing means 417 and may include range sensing characteristics from the range sensing means 415. The processing means 429 further includes a 3D scene modeling means (means for modeling a scene) 421, a tag reading means 423 and a rendering means 440. The 3D scene model means 421 further includes a 3D scene model 427, multiple propagating modalities 422 and multiple surface morphologies 431. The visual display means 435 displays the frames created by the rendering means 440 that provides a notion of the shape, size and location of the 3D surface 405 and information about the tag 425. The visual display means 435 includes a head tracking means 445 used by the rendering means 440 to create a depth cue based on motion parallax. It is to be appreciated that entities depicted in the processing means 429 and the display means 435 could be physically located inside or outside of the body of the camera 401.

The exemplary embodiment is a passive device, meaning that it does not emit its own illumination. It is to be appreciated that auxiliary light such as a flash could be used to supplement natural light in the case of the 3D visual cognition camera 401.

It is to be appreciated that the sensed energy 403 used by the 3D visual cognition camera 401 (FIG. 4A) to create the 3D scene model 427 (FIG. 4B) in other embodiments is not restricted to the visible spectrum. The phase characteristic sensing means 411 will function in all regions of the electromagnetic spectrum including the microwave, visible/near-infrared, visible, ultraviolet and x-ray regions. The different ways that electromagnetic energy 403 at various wavelengths interacts with matter makes it advantageous to use electromagnetic energy at specific wavelengths for specific applications. For example, phase characteristic sensing in the far visible/near-infrared spectrum where surfaces radiate naturally (blackbody radiation) enables completely passive operation (no active illumination) of the 3D visual cognition camera during the day or night. Sensing in the visible spectrum enables completely passive operation (no active illumination) of the 3D visual cognition camera during the day. Sensing in the mid IR region enables 3D night vision. Sensing in the terahertz region allows the 3D visual cognition camera to “see through” clothing in 3D. Sensing in the ultraviolet region enables ultra-high resolution modeling. Sensing in the x-ray region enables bones and internal surfaces to be three-dimensionally imaged.

It is to be appreciated that electromagnetic energy 403 used by the 3D visual cognition camera 401 (FIG. 4A) to create the 3D scene model 427 (FIG. 4B) can be randomly, partially or fully polarized.

### Conveying Means

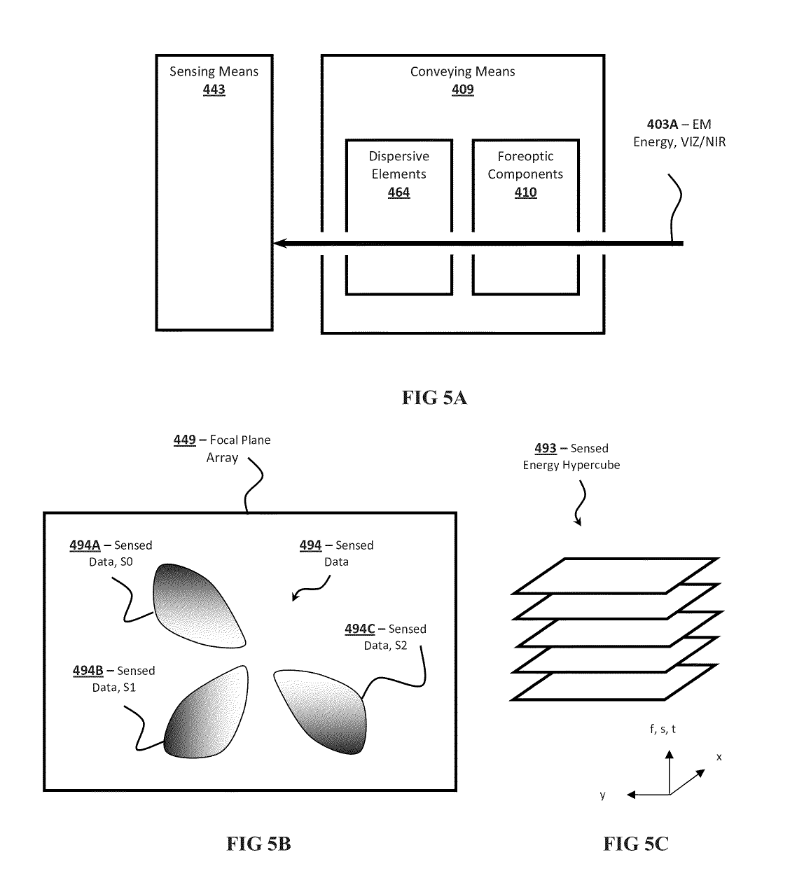

Referring to FIG. 5A, the conveying means (or means for conveying) 409 of the exemplary embodiment 3D visual cognition camera 401 (FIG. 4A) utilizes lenses as foreoptic components 410 and one or more dispersive elements 464 to convey sensed energy 403 to the sensing means 443. Referring to FIG. 5B, the dispersive elements in the exemplary embodiment cause the sensed energy 403 to be dispersed across the focal plane array 449 into three or more regions, the regions are named sensed data, S0 494A, sensed data, S1 494B, sensed data, S2 494C. Region 494A contains the part of the sensed energy 403 that is not polarized and is dispersed by frequency as depicted by the gradient from white to black. Region 494B contains the part of the sensed energy 403 that is linearly polarized in one mode and is dispersed by frequency. Region 494C contains the part of the sensed energy 403 that is linearly polarized in another mode and is dispersed by frequency.

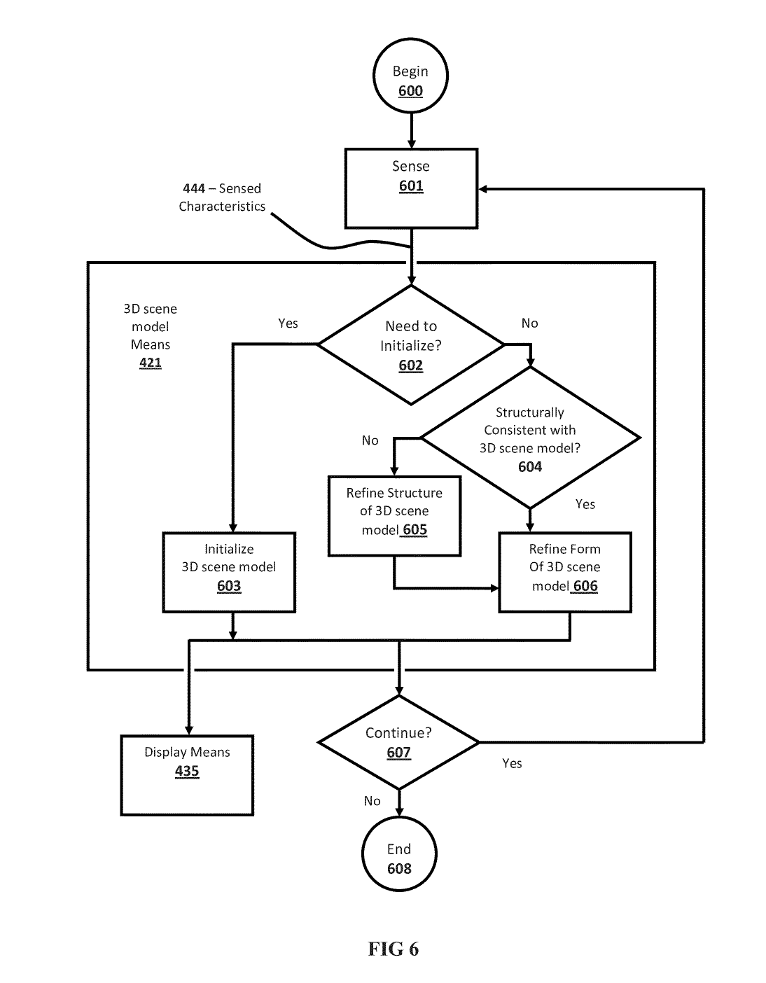

It is to be appreciated that in other embodiments other arrangements of foreoptic components 410 (FIG. 6G) can be utilized to convey electromagnetic energy 403 to the sensing means 443 (FIG. 4B) depending on the specific application. Examples of foreoptic components 410 (FIG. 6G) for conveying electromagnetic energy for 3D Visualization Systems include refractive elements, reflective elements, diffractive elements, dichroic filters, lenses, mirrors, catoptric elements, fiber optic elements, micromirror arrays, microlens arrays, baffles, holographic optical elements, diffractive optical elements, beam steering mechanisms, or other devices (e.g., one or more of a refractive element, a reflective element, a diffractive element, a lens, a mirror, a fiber optic element, a microlens array, a baffle, a micromirror array, a catoptric element, a holographic optical element, a diffractive optical element, a beam steering mechanism, an element including metamaterials, an element including birefringents, a liquid crystal, a nematic liquid crystal, a ferroelectric liquid crystal, a linear polarizer, a wave plate, a beam splitter or a light emitting diode a form birefringent). A plurality of laterally located lens elements, for example, might be used to take advantage of multi-camera phenomena such as multi-view correspondence. Catoptric elements, for example, might be used to design wide angle conveying means 409 for 3D security cameras approaching a hemisphere. Beam steering mechanisms, for example, might be used to expand the camera 401 (FIG. 4A) field of view even further. Microlens arrays, for example, might be used to take advantage of numerical imaging phenomena such as super-resolution, greater depth of field, greater dynamic range and depth estimation.

### Processing and Sensing Means

### Computational Tomography

The processing means 429 further includes a sensed energy modeling means (or means for modeling sensed energy) 491. Referring to FIG. 5C, the sensed energy detected by the focal plane array 449 (FIG. 5B) is processed using computational tomography techniques into a sensed energy model 492 (FIG. 4B) depicted as a sensed energy hypercube 493. The sensed energy hypercube 493 is depicted with focal plane array 449 (FIG. 5B) axes running horizontally in the x and y directions, and with other dimensions, including the frequency, polarization and time dimensions, running vertically. In this way, the frequency and polarization state at a pixel on the focal plane array 449 (FIG. 5B) as a function of time is represented. Thus, the means for modeling a scene can further include means for modeling changing polarization of the energy as it interacts with the surfaces. Also, such provides an example means for performing computational tomography and the sensed energy model is thus an image hypercube.

### SPI Equations

After the sensed energy at a pixel in the focal plane array 449 (FIG. 5B) has been calculated, equations can be used to compute normal orientation. For simplicity, we will proceed to describe equations assuming that linear polarization at orientations 0 deg, 45 deg and 90 deg are used to sense the orientation of a surface element. It is to be appreciated that are many ways that polarization characteristics can be separated by the conveying means 409. Also, a redundant sets of characteristics can be used.

We introduce, auxiliary variables (v₁. . . v₄), where I₀ is the intensity detected at the 0 degree subpixel, I₄₅ is the intensity detected at the 45 degree subpixel, and so forth

(v₁=I₉₀−I₀)

(v₂=I₄₅−I₀)

(v₃=I₉₀−I₄₅)

(v₄=I₉₀+I₀)

The equations to compute DoLP and Theta from the auxiliary variables are as follows:

$$θ = - \frac{1}{2} {tan}^{- 1} ( \frac{{v}_{2} + {v}_{3}}{{v}_{1}} )$$

$$ρ ( DOLP ) = \frac{\sqrt{{v}_{1}^{2} + {v}_{2}^{2} + {v}_{3}^{2} + 2 {v}_{2} {v}_{3}}}{{v}_{4}}$$

The equations to compute the direction cosigns of the normal vectors at the i,j th pixel, where α, β, and γ are the directional cosines for X, Y, and Z respectively and scale is a function use to compute

$${α}_{i , j} = acos ( cos ( \frac{π}{2} - {γ}_{i , j} ) \cdot cos ( {θ}_{i , j} - \frac{π}{2} ) )$$

$${β}_{i , j} = acos ( cos ( \frac{π}{2} - {γ}_{i , j} ) \cdot cos ( {θ}_{i , j} ) )$$

$$γ = scale ( scale\_DoLP , 0 , \frac{π}{2} )$$

Once the directional cosines for each pixel are known, the x, y, and z, coordinates for the surface normal at each target/object pixel can be found:

x_{i,j}=cos(α_{i,j})

y_{i,j}=cos(β_{i,j})

z_{i,j}=cos(γ_{i,j})

Note that since the x, y, and z, values are based on the normalized values of the directional cosines the resulting 3D object is created in normalized space.

With the directional cosines (and other calculated information) for each target pixel, the 3D surface of the is stitched together using “seed” pixels and surface integration. Seed pixels are predefined pixels set up on a grid basis across the target in the image plane. They are located throughout the overall target grid and make up a small percentage of the overall number of pixels. A sub-mesh build begins with each seed pixel, using the direction cosines to stitch the nearest neighbor pixels together, forming a larger surface. The process is iteratively completed for all seed pixels until the sub-mesh has been completed. Automated algorithms assist in the best placement and concentration of seed pixels to minimize error and computational effort. The result is a 3D scene model of the imaged object yielding geometric sizes and shapes.

The net electric field vector associated with a beam of electromagnetic energy emanating from a surface element sweeps out an elliptical form in a plane perpendicular to the direction of travel called the polarization ellipse. As this electromagnetic wave interacts with various surfaces through emission, transmission, reflection, or absorption, the shape and orientation of the polarization ellipse is affected. By sensing the ellipticity and orientation of the polarization ellipse surface normal orientations can be determined. The shape and orientation of the polarization ellipse can be determined from a set of spatial phase characteristics. The shape, or ellipticity, and is defined in terms of the degree of linear polarization, or DoLP. The orientation of the major axis of the polarization ellipse (not to be confused with the orientation of the normal to a surface element) is defined in terms of Theda, θ, which is the angle of the major axis from the camera X axis projected onto the image plane.

The focal plane array 449 (FIG. 5B) of the sensing means 443 used in the exemplary camera 401 (FIG. 4A) is a high dynamic range (500,000:1) SiPIN detectors, with 15 um pixel, 4 megapixel focal plane array with, hybrid design and a 75 Hz frame rate. It is understood that the focal plane array 449 (FIG. 5B) can use metamaterials, optical antenna a direct image sensor, a multi-sampling sensor, a photon counter, a plasmonic crystal, quantum dots, an antenna-coupled metal-oxide-metal diode or other detector technologies to accomplish the detection function. It is understood that high dynamic range is important in shape from polarization because the partially polarized signals may be relatively weak. Mechanisms to increase dynamic range include: active pixel sensor technology, non-destructive correlated double sampling (CDS) at each pixel, photon counting, and delta sigma converters. If provided within an integrated circuit chip, such may be via on-chip arrangement or means. Accordingly, the sensing means (means for sensing) can include one or more on-chip means to increase dynamic range, including one or more of an active pixel sensor, a delta-sigma converter and a subtraction technique under which sets of adjacent pixels are subtracted to form auxiliary on-chip differences that can be used to compute the orientations of surface elements.

It is to be appreciated that the circular polarization characteristic is not required when the camera 401 (FIG. 4A) is used to image most natural surfaces, since most natural surfaces do not cause electromagnetic energy to become circularly polarized. But, retarders of various sorts and designs can be used in conveying means 409 (FIG. 5A) to create regions of sensed data 494 (FIG. 5B) that represent circular polarization state.

### Location Sensing

The exemplary embodiment 3D visual cognition camera 401 (FIG. 4A) depicted in FIGS. 4A and 4B incorporates a six axis accelerometer 447 (three linear displacements, three rotational displacements) which is used in conjunction with the spatial phase characteristic sensing means 453 (FIG. 4B) to estimate the location of the camera 401 (FIG. 4A). It is to be appreciated that many different types of pose sensing methods could be used to sense location characteristics any one of which might be preferred depending on the application. Location sensing devices might include: global positioning system (GPS), differential GPS, gravitational sensors, laser trackers, laser scanners, acoustic position trackers, magnetic position trackers, motion capture systems, optical position trackers, radio frequency identification (RFID) trackers, linear encoders and angular encoders.

It is to be appreciated that gravitational sensors can be utilized by new visual cognition systems to sense the local vertical (up). This information aids in scene segmentation (ground is generally down, sky is generally up). However, in the exemplary embodiment, we assume that the camera operator holds the camera in an upright position.

### Spectral Sensing

It is to be appreciated that the exemplary camera 401 (FIG. 4A) enables spectral-polarimetric detection. Spectral detectors of many sorts can be included to address other applications. Here, by spectral detectors, we mean detectors that sense total intensity in a certain frequency band. For example, sensors to capture color can be included when visible intensity contrast is required. Multi-spectral and hyperspectral sensors can be included to extract surface characteristic information for purposes of object identification. Intensity contrast enabled by spectral sensors can supplement shape contrast during the 3D scene modeling process. It is to be appreciated that spectral sensing pixels can located on detectors that are distinct from spatial phase characteristic sensing pixels or can be interspersed with spatial phase pixels in many different configurations.

It is to be appreciated that other observations, such as spectral intensity characteristics, can be used in likelihood adjusted combination with normal vectors to segment the at least one 3D surfaces 405 (FIG. 4A).

### Range Sensing

One exemplary embodiment 3D visual cognition camera 401 (FIG. 4A) does not include range means (or means for sensing one or more range characteristics) 415, but such is nonetheless shown in FIG. 4B. However, it is to be appreciated that range detectors of many sorts can be included in 3D visualization systems to address other applications. For example, time of flight (TOF) focal plane arrays can be included in the sensing means 443 (FIG. 4B) to capture ranges from the camera 401 (FIG. 4A) to surface elements 407 (FIG. 4A) on surfaces 405 (FIG. 4A). Other ranging sensors include depth from focus, depth from defocus, monocular correspondence, pulsed TOF, continuous modulation TOF or coherent technologies, acoustic or electromagnetic energy, and spot, line or no scanning systems (e.g. focal plane arrays). It is to be appreciated that range sensing pixels can located on detectors that are distinct from spatial phase characteristic sensing pixels or can be interspersed with spatial phase pixels in many configurations. Thus, range means being present or absent are possibilities and contemplated.

### Scene Modeling

The 3D scene modeling process is schematically described in FIG. 6. The basic steps involved in creating the 3D scene model other than beginning 600 and ending 607 are sensing 601 under which step scene characteristics are created, initialization 602 and 603 under which steps the scene model is initialized if required and refinement 604, 605 and 606, under which steps the scene model is refined. The model is periodically rendered by the Display Means 435. The scene model is periodically refined 607.

Sensing. The first embodiment modeling process is described in FIG. 6. The 3D scene modeling process, including initialization or refinement, begins with a sense operation 601 initiated when control means 451 triggers spatial phase characteristic sensing means 453 and location characteristics sensing means (or means for sensing location characteristics) 417. Sensed characteristics 444 are created that include three spatial phase characteristics per camera 401 pixel and six camera acceleration characteristics including three translations and three rotations.

Initialization. If initialization is required 601, the initialization step will be accomplished. The 3D scene model 427 needs to be initialized 603 when, for example, the camera 401 is first sensing a new scene and therefore creating the first set of sensed characteristics 444. Spatial phase characteristics 444 are utilized to determine surface element orientations associated with each pixel in the camera 401 using the spatial phase imaging equations described above. Normal vectors are utilized to represent surface element orientations. The normal vectors are spatially integrated and segmented to create one or more 3D surfaces 405. By default, the morphology of each 3D surface 405 is set to rigid. The dense field of orientation vectors provides high probability means for segmentation. Shape boundaries between surfaces are unaffected by changing illumination, for example, the way that intensity features change. Most natural objects will exhibit a dense set of near 90 degree normal vectors (with respect to the camera 401 axis) on the occluding boundaries. It is to be appreciated that other sensed characteristics, such as spectral characteristics, can be used in combination with normal vectors to segment the one or more 3D surfaces 405.

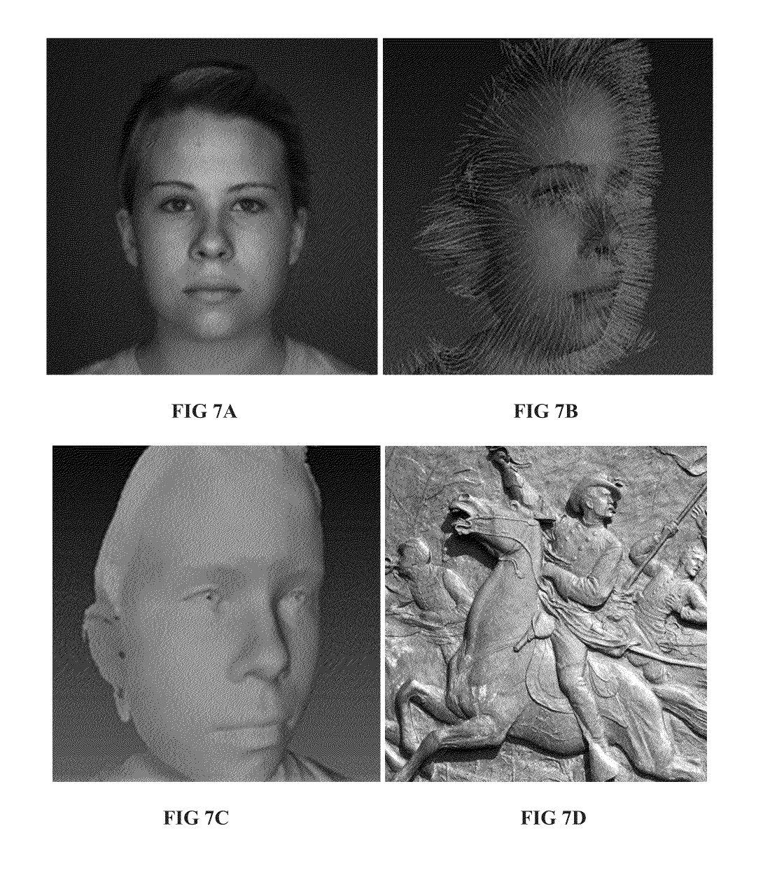

The photographs in FIG. 7 are illustrative of the initialization process. FIG. 7A depicts a visible light photo of a woman's face. In FIGS. 7A, B and C, background surfaces have been removed for clarity. FIG. 7B depicts normal vectors over the face after surface integration. FIG. 7C depicts a 3D scene model created from a single frame of data utilizing a spatial phase characteristic sensing IR camera. Since the first embodiment camera 401 includes a nominally flat focal plane array, the 3D surfaces created from the first frame of spatial phase characteristics after surface integration have the proper shape, but the relative distances between surfaces cannot be determined.

The surface model created during the initialization process of the first embodiment is similar to the bas-relief sculpture illustrated in FIG. 7D and will hereinafter be referred to as a bas-relief model. The one or more surfaces 405 that comprise the 3D scene model 427 have 3D shape, but the relative location in depth of the 3D shape and depth cannot be determined without relative motion.

It is to be appreciated that a spatial phase characteristic sensing means 453 can be configured to enable surface elements 407 to be simultaneously sensed from a plurality of directions. This can be accomplished, for example, by locating a plurality of conveying means 409 and sensing means 443 and in close proximity on a planar frame, or by locating a plurality of conveying means 409 and sensing means 443 on the inside surface of a hemisphere. In this case, the initial surface would not a bas-relief model, but rather would be a fully developed 3D scene model. The initialization process in this case would determine the correspondence of features of form (3D textures as opposed to contrast textures) in order to determine the form and structure of the 3D scene model 427.

It is to be appreciated that other information such as the approximate size of objects including faces or other sensed information, including depth from focus or defocus, provides enough information that a fully developed 3D scene model can be created on initialization.

The 3D scene model 427 has certain structural characteristics such as surface 405 boundaries and certain form characteristics such as surface 405 shape, size and location.

Refinement. Additional frames of sensed characteristics 444 can be processed by the 3D scene modeling means 421 including steps 601 and 607 to refine the 3D scene model 427. If no relative motion occurs between the camera 401 and the one or more surfaces 405, characteristics can be averaged to reduce 3D scene model errors thereby improving the 3D scene model 427. If relative motion occurs, additional refinement of the structure at step 605 and/or additional refinement of the form at step 606 of the 3D scene model 427 by the 3D scene modeling means 421 can be accomplished.

The first embodiment camera 401 senses relative motion in two ways: via changes in spatial phase characteristics 411 and via changes in six camera acceleration characteristics. When sensing rigid and stationary surfaces (that would typically comprise, for example, the background of a scene) these two sources of relative motion sensing are redundant and can be utilized for real-time calibration and for segmentation.

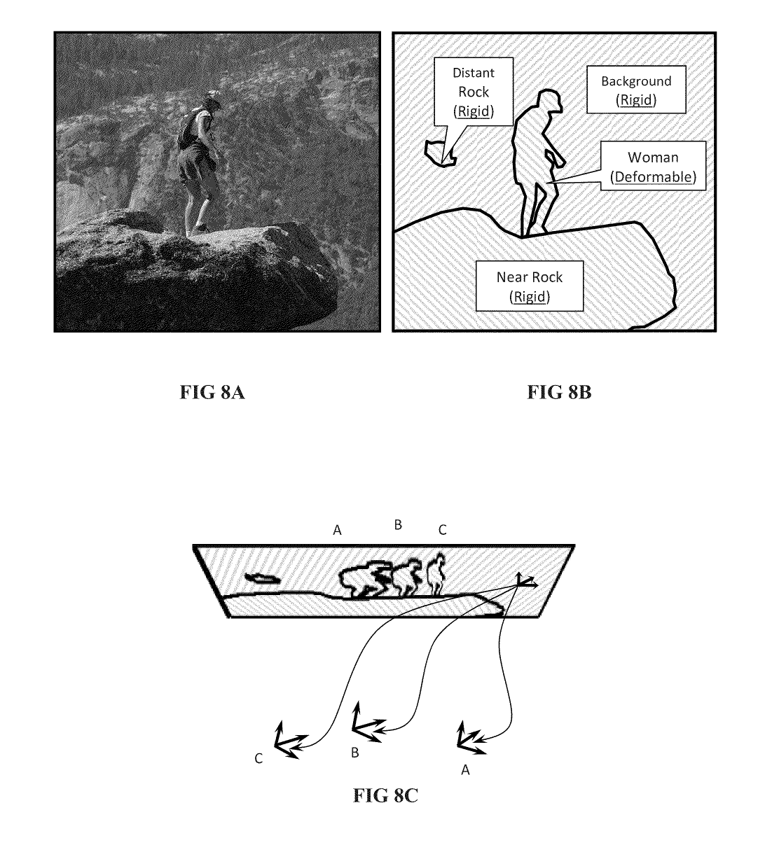

Referring to the FIGS. 8A, 8B and 8C, relative motion could be caused, for example, by transporting the camera 401 from the photographer's right to left. The relative motion could also be caused as the women standing on the precipice walks to the right and stands more erect. Or the motion could be some combination of camera 401 motion relative to the earth and motion of the woman relative to the precipice.

The various types of relative motion are detectable by the camera 401 and can be used to refine the segmentation of surfaces 405 into various categories, for example: rigid (e.g. a rock) and stationary (relative to some reference frame such as the earth); rigid and moving; deforming in shape (e.g. a human being), deforming in size (e.g. a balloon). Note, for example, that the normal vectors associated with surface elements 407 belong to a surface 405 that is rigid (whether moving or not) will all rotate in a nominally identical manner (whether or not the camera is moving). Since rotation of the camera is sensed by the location sensing means 417 rigid rotation of surfaces can be distinguished from camera 405 rotation. The normal vectors that are associated with deformable surfaces reorient as the shape of the deforming surface changes.

Utilizing the states of normal vectors included in a 3D surface, it can be determined whether or not the state is consistent with the current state of the scene model.

3D surfaces are sets of adjacent surface elements that behave in accordance with the morphology: rigid, deformable or particle.

A rigid morphology is used for rigid bodies, which may or may not be moving.

A deformable model is one that is experiencing changing shape or size and there is some set of constraints that cause the surface elements to move in some correlated deterministic manner

A particle model is used to represent certain phenomena like smoke, water and grass. There are some constraints that cause the surface element to move in a correlated manner, but it is treated as having some random properties.

The 3D surface associated with a bird, for example, that is still during the initialization step, but begins to fly thereafter, would be initially classified to be rigid, but thereafter would be represented as a deformable model.

A minimum energy deformable model is an example of a representation used by the camera 401.

Referring to FIG. 8C, a weighted least squares bundle adjustment technique is used to accomplish the simultaneous shape, size and location of the one or more 3D surfaces 405 in a coordinate frame network as suggested by FIG. 8C. It is to be appreciated that other methods of shape similarity can be used including Boolean occupancy criteria using solid models.

Multiple Scattering Modalities. It is to be appreciated that the electromagnetic energy 403 emanating from a surface element 407 can be generated and/or influenced by many physical phenomena including radiation, reflection, refraction and scattering, which are described in the literature including the cited references. As appropriate, the spatio-temporal orientation determining means 419 must properly account for a plurality of such phenomena, including specular reflection, diffuse reflection, diffuse reflection due to subsurface penetration, diffuse reflection due to micro facets, diffuse reflection due to surface roughness and retro-reflective reflection. Thus, the means for modeling a scene can further includes means to represent a plurality of scattering modes including at least two of specular reflection, diffuse reflection, micro facet reflection, retro-reflection, transmission and emission. It is to be appreciated that the uncertainty of the determined orientations will vary as a function of such things as angle (the zenith angle between the surface element normal and the 3D thermal camera axis), the nature of the interaction of the electromagnetic energy and the surface element and the signal to noise ration of the electromagnetic energy returned to the 3D Visualization System. These uncertainties can be determined and used as appropriate to suppress orientations when uncertainties are below predetermined levels, to determine 3D scene models in an optimum sense when redundant data are available, and to actively guide 3D thermal camera operators to perfect 3D scene models by capturing addition 3D video data to improve the uncertainty of areas of the surface.

Multiple Morphologies. The 3D scene modeling process is schematically described in FIG. 6.

By configuration, we mean the location, shape and/or size of the 3D surfaces relative to the camera 401. A 3D surface 405, is a section of a real watertight surface for which a set of orientations can be integrated.

3D surfaces are sets of adjacent surface elements that behave in accordance with the morphology: rigid, deformable or particle. Thus, the means for modeling a scene can further include means to represent the surface elements in one or more of the following morphologies: rigid, deformable and particle.

A rigid morphology is used for rigid bodies, which may or may not be moving.

A deformable model is one that is experiencing changing shape or size and there is some set of constraints that cause the surface elements to move in some correlated deterministic manner

A particle model is used to represent certain phenomena like smoke, water and grass. There are some constraints that cause the surface element to move in a correlated manner, but it is treated as having some random properties.

The 3D surface associated with a bird, for example, that is still during the initialization step, but begins to fly thereafter, would be initially classified to be rigid, but thereafter would be represented as a deformable model.

A minimum energy deformable model is an example of a representation used by the camera 401. It is to be understood that there are other techniques know to those skilled in the art including: principal component analysis (PCA), probabilistic graphical methods making use of Bayesian and Markov network formalisms, non-rigid iterative closest point, skeletonization (medial axis), Octrees, least-squares optimization, 3D morphable models, 3D forward and inverse kinematics, shape interpolation and basis functions.

Reflectance Field. One or more reflectance properties from one or more angles are stored in the 3D scene model 427.

It is to be appreciated that the spatial integration and segmentation process can be a massively parallel process using, for example, GPUs or DSPs to process subgroups of pixels before combining results into a single image.

Solid Modeling. It is to be appreciated that solid models including octree models are particularly good way to represent the 3D surfaces 405. Solid models are fully 3D. Full 3D model, readily refined, can determine occupancy on a probabilistic basis, hierarchical and spatially sorted, enabling compact storage and efficient refinement. Thus, the scene model can be solid, spatially sorted and hierarchical.

### 3D Display

Referring to FIG. 4A, the first embodiment camera 401 includes an on-board display means 435 which is utilized to render the 3D scene model 427 in real-time. The 3D scene model 427 is typically rendered from the point of view of the exemplary camera 401. Small perturbations in rendered viewing angle are utilized at operator option, for example, to achieve three-dimensional effects such as wiggle stereoscopy. Wiggle stereoscopy generates a monocular 3D effect by alternating between two slightly displaced views of the same scene. And large perturbations in rendered viewing angle are utilized in a non-real-time mode to, for example, enable the 3D scene model 427 to be viewed historically. Monocular depth cues inherent in the sensed 3D scene model 427 of the one of more surfaces 405 include perspective, motion parallax, kinetic depth perception, texture gradient, occlusion, relative size and familiar size. Monocular depth cues that are synthesized by the camera 401 at the option of the operator include lighting, shading, aerial perspective and enhancement of any of the previously mentioned inherent cues. Lighting, shading and aerial perspective all must be entirely synthesized since they are not sensed at thermal frequencies. The inherent depth cues can be modified to enhance the operator's sense of three-dimensionality by altering the rendering process. For example, perspective could be exaggerated to make perspective more or less extreme.

It is to be appreciated that in other embodiments synthesized binocular depth cues could be used by binocular, stereoscopic or other non-conventional display means 435 to further enhance the sense of three-dimensionality experienced by human observers of the display. Binocular depth cues include stereopsis and convergence. Thus, the system can include means for displaying the scene model in real-time, wherein said means for displaying includes means for synthesizing depth cues

It is to be appreciated that image compression 439A (FIG. 4B) and decompression 439B (FIG. 4B) could be used in other embodiments to reduce the number of bits of information traveling over the data transmission channel between the 3D scene modeling means 427 and the display means 437. The compression can be lossy or lossless; intraframe (spatial), interframe (temporal) or model-based depending on the particular application.

It is to be appreciated that real-time head tracking could be used by other embodiments to create a synthetic motion parallax depth cue on a conventional display.

### Tag Reading

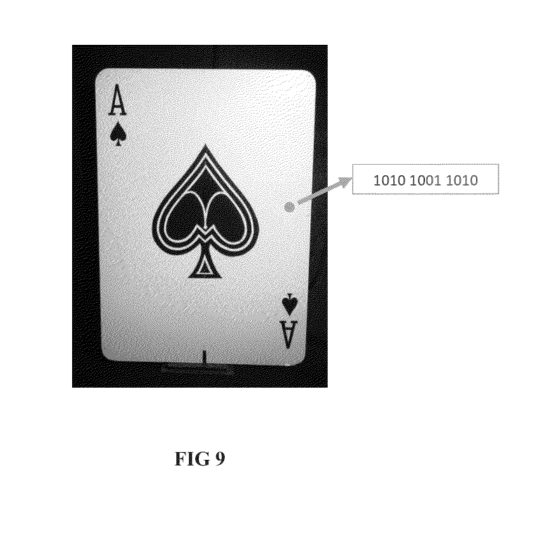

Referring to FIG. 4A, the first embodiment camera 401 includes a tag reading means 423 for reading tags 425 applied to a 3D surface 405. The tags 425 utilize oriented materials which interact with electromagnetic energy 403B to affect its spatial phase characteristics, thereby encoding information that can be sensed by sensing means 443 including Spatial Phase Characteristic Sensing Means 453. Information is represented on the surface 405 in terms of presence or absence of material or in terms of one or more angles that can be determined by the camera 401. Thus, the system can include means for determining from a plurality of polarization characteristics one or more of a tag location or information encoded into the tag including a 3D image, the means for modeling a scene utilizing the location or the information encoded into the tag. Tags can be made to be invisible to the eye. FIG. 9 depicts using false color green the use of an invisible tag 425 on a playing card.

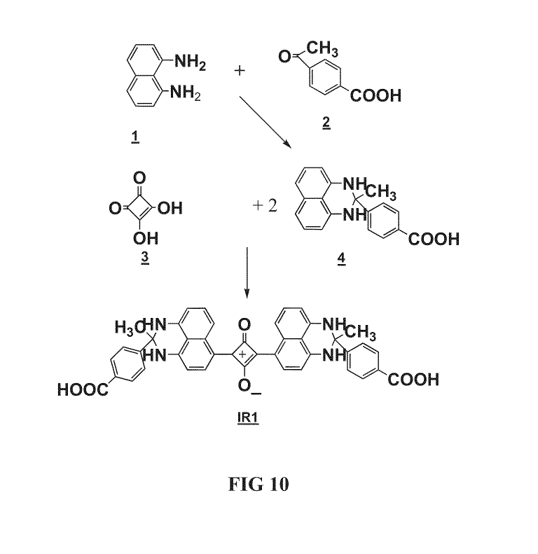

The first embodiment camera 401 employs a clear optical tag that is 0.001 inches thick with a clear IR dichroic dye. The thin film uses an optically clear laminating adhesive material that is laminated onto stretched PVA. FIG. 10 illustrates a sequence of reactions used to prepare a dye labled “IR1” that is used to create tags 425.

It is to be appreciated that tagging materials can be liquids and thin film taggant compounds, in various tinted transparent forms. Materials which could be used include elongated paint dyes, polyvinyl alcohol (PVA), nanotubes, clusters of quantum dots, and liquid crystal solutions that are uniquely oriented. Nylon thread can be coated with liquid crystals, thus creating a tagging thread which could be woven into the fabric, or perhaps be the fabric. Tags could be delivered according to methods including: Self-orienting liquid in an aerosol or liquid delivery. Use molecular-level orientation for liquid crystals or graphite nanotubes. Each of these has an aspect ratio greater than 10:1 and possesses a charge, which makes them orient. Macroscale particles which orient themselves in unique patterns on the target. These would be larger particles on the order of a mm or greater in size that can be shot or projected onto the target. Each particle will have its own orientation and together they will make up a unique signature.

It is to be appreciated that taggants can blend very well with their backgrounds and be nearly impossible to detect with the unaided eye or conventional sensors.

### Other Functions

The first embodiment camera 401 includes means for other functions 437 including saving the 3D scene model to disk. It is to be appreciated that means for many other functions might be included in the first embodiment camera 401, depending on the applications, including one of automatic audio, manual audio, autofocus, manual focus, automatic exposure, manual exposure, automatic white balance, manual white balance, headphone jack, external microphone, filter rings, lens adapters, digital zoom, optical zoom, playback and record controls, rechargeable batteries, synchronization with other the apparatus and image stabilization.

### Information Extraction

The system can include means for extracting information about the scene using the scene model, thereby creating auxiliary models. The auxiliary models can represent one or more of a 3D video, a compressed 3D video, a noise suppressed 3D video, a route, a description, an anomaly, a change, a feature, a shape, sizes, poses, dimensions, motions, speeds, velocities, accelerations, expressions, gestures, emotions, deception, postures, activities, behaviors, faces, lips, ears, eyes, irises, veins, moles, wounds, birthmarks, freckles, scars, wrinkles, fingerprints, thumbprints, palm prints, warts, categories, identities, instances, scene of internal organs, breasts, skin tumors, skin cancers, dysmorphologies, abnormalities, teeth, gums, facial expressions, facial macro expressions, facial micro expressions, facial subtle expressions, head gestures, hand gestures, arm gestures, gaits, body gestures, wagging tails, athletic motions, fighting positions, lip reading, crawling, talking, screaming, barking, breathing, running, galloping, eating, gun raising, axe swinging, phone talking, guitar playing, crowd behavior, health, mental state, range of motion, performance, weight, volume and concealed objects.

### CONCLUSION

While the invention has been described above and illustrated with reference to certain embodiments of the invention, it is to be understood that the invention is not so limited. Modifications and alterations will occur to others upon a reading and understanding of the specification, including the drawings. In any event, the invention covers and includes any and all modifications and variations to the embodiments that have been described and that are encompassed by the following claims.

What is claimed is:

1. A visual cognition system, the system is immersed in a medium, one or more objects are immersed in the medium, the system is also an object, electromagnetic energy propagates in the medium, the objects, the energy and the medium comprise a 3D scene, the boundaries between the objects and the medium are surfaces, some of the electromagnetic energy scatters from the surfaces, the system includes:
means for conveying energy, which include one or more dispersive elements, the means for conveying receives some of the energy from the scene,
means for sensing energy, the sensed energy is received from the means for conveying, the means for sensing include a plurality of detectors, the detectors detect the intensity of sensed energy at video rates and at high dynamic range, thereby creating sensed data,
means for modeling sensed energy, thereby creating a sensed energy model, the sensed energy model represents the sensed energy at a plurality of frequency bands, a plurality of polarization states, a plurality of positions and a plurality of times, using the sensed data, and
means for modeling a scene, thereby creating a scene model, the scene model represents the scene in three-dimensional space, the means for modeling a scene uses the sensed energy model from a plurality of directions at a plurality of times.

2. The system of claim 1 wherein the means for modeling sensed energy includes a means for performing computational tomography and the sensed energy model is an image hypercube.

3. The system of claim 1 wherein the means for modeling a scene further includes means to represent the surface elements in one or more of the following morphologies: rigid, deformable and particle.

4. The system of claim 1 wherein the means for modeling a scene further includes means for modeling changing polarization of the energy as it interacts with the surfaces.

5. The system of claim 1 wherein the scene model is solid, spatially sorted and hierarchical.

6. The system of claim 1 wherein the means for conveying includes one or more of a refractive element, a reflective element, a diffractive element, a lens, a mirror, a fiber optic element, a microlens array, a baffle, a micromirror array, a catoptric element, a holographic optical element, a diffractive optical element, a beam steering mechanism, an element including metamaterials, an element including birefringents, a liquid crystal, a nematic liquid crystal, a ferroelectric liquid crystal, a linear polarizer, a wave plate, a beam splitter or a light emitting diode a form birefringent.

7. The system of claim 1 wherein the means for sensing includes one or more of a focal plane array, a direct image sensor, a multi-sampling sensor, a photon counter, a plasmonic crystal, quantum dots, an antenna-coupled metal-oxide-metal diode.

8. The system of claim 1 wherein the means for sensing includes one or more on-chip means to increase dynamic range, including one or more of an active pixel sensor, a delta-sigma converter and a subtraction technique under which sets of adjacent pixels are subtracted to form auxiliary on-chip differences that can be used to compute the orientations of surface elements.

9. The system of claim 1 which further includes means for sensing one or more range characteristics to the scene, the means for modeling a scene utilizing the range characteristics.

10. The system of claim 1 which further includes means for sensing one or more location characteristics of the system in the scene, the means for modeling a scene utilizing the location characteristics.

11. The system of claim 1 wherein the means for modeling a scene further includes means to represent a plurality of scattering modes including at least two of specular reflection, diffuse reflection, micro facet reflection, retro-reflection, transmission and emission.

12. The system of claim 1 which further includes means for determining from a plurality of polarization characteristics one or more of a tag location or information encoded into the tag including a 3D image, the means for modeling a scene utilizing the location or the information encoded into the tag.

13. The system of claim 1 which further includes means for displaying the scene model in real-time, wherein said means for displaying includes means for synthesizing depth cues.

14. The system of claim 1 which further includes means for extracting information about the scene using the scene model, thereby creating auxiliary models, wherein the auxiliary models represent one or more of a 3D video, a compressed 3D video, a noise suppressed 3D video, a route, a description, an anomaly, a change, a feature, a shape, sizes, poses, dimensions, motions, speeds, velocities, accelerations, expressions, gestures, emotions, deception, postures, activities, behaviors, faces, lips, ears, eyes, irises, veins, moles, wounds, birthmarks, freckles, scars, wrinkles, fingerprints, thumbprints, palm prints, warts, categories, identities, instances, scene of internal organs, breasts, skin tumors, skin cancers, dysmorphologies, abnormalities, teeth, gums, facial expressions, facial macro expressions, facial micro expressions, facial subtle expressions, head gestures, hand gestures, arm gestures, gaits, body gestures, wagging tails, athletic motions, fighting positions, lip reading, crawling, talking, screaming, barking, breathing, running, galloping, eating, gun raising, axe swinging, phone talking, guitar playing, crowd behavior, health, mental state, range of motion, performance, weight, volume and concealed objects.
